(19) United States
(12) Patent Application Publication
(10) Pub. No.: US 2006/0067582 A1
(43) Pub. Date: Mar. 30, 2006

(54) Progressive JPEG decoding system

(75) Inventors: Mi Michael Bi, Singapore (SG); Ming Chet Liew, Singapore (SG); Keng Liang Loi, Singapore (SG); Yudhi Santoso, Singapore (SG)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 11/230,516

(22) Filed: Sep. 21, 2005

(30) Foreign Application Priority Data
Sep. 22, 2004 (JP) 2004-275053

(51) Int. Cl. G06K 9/36

(52) U.S. Cl. 382/233

(57) ABSTRACT

An apparatus and a method for efficient decoding progressive JPEG bitstreams are invented. This invention provides a memory-efficient progressive JPEG decoding method with minimal memory requirements. Instead of storing all the DCT coefficients of at particular decoding scan, a portion of DCT coefficients and the non-zero coefficient indicators for the rest of the DCT coefficients are stored in either original data format or in a compressed format. The memory requirement for decoding progressive JPEG pictures can be minimized according to the resolution of display devices in the real applications.

### BACKGROUND OF THE INVENTION

The present invention relates image decompression for progressively compressed images. More specifically, the invention relates to decompression method of progressive JPEG.

The JPEG (Joint Photographic Experts Group) introduced a still image graphics format in 1987, known as JPEG “ISO 10918”, which has become the dominant format for still-image compression. It is popular among applications such as digital cameras and is widely used across the web. Most commonly JPEG uses a lossy compression algorithm, signifying that information is removed from the image when compressing. JPEG offers distinct advantages in both picture quality and the responding file size.

The JPEG standard is described in a number of publications Wallace, “The JPEG still picture compression standards”, IEEE Transactions on Consumer Electronics, vol. 34, No. 4, pp. 30-44, April, 1991. A progressive JPEG is the JPEG equivalent of the interlaced GIF (Graphics Interchange Format). It's an image created using the JPEG suite of compression algorithms that will “fade in” in successive waves of lines until the entire image has completely arrived. (refer to H. S. Stone, “Progressive JPEG decoding”, U.S. Pat. No. 6,259,820, Jul. 10, 2001)

A simple or baseline JPEG file is stored as one top-to-bottom scan of the image. Progressive JPEG divides the file into a series of scans. The first scan shows the image at the equivalent of a very low quality setting, and therefore it takes very little space. Following scans gradually improve the quality. Each scan adds to the data already provided, so that the total storage requirement is roughly the same as for a baseline JPEG image of the same quality as the final scan. Compared to baseline JPEG, the progressive JPEG is a rearrangement of the same data into a more complicated order.

The advantage of progressive JPEG is that if an image is being viewed on-the-fly as it is transmitted, one can see an approximation to the whole image very quickly, with gradual improvement of quality as one waits longer; this is much nicer than a slow top-to-bottom display of the image.

A progressive JPEG file is not readable at all by a baseline-only JPEG decoder, additional operations have to be added to the baseline JPEG decoder to decode progressive JPEG bitstreams.

One of the most serious problems in progressive JPEG decoder is that the memory space required to store intermediately decoded information at each decoding scan is huge compared to that required for baseline JPEG decoding. This is because all the intermediate decoded DCT coefficients need to be stored in the memory and these coefficients will be updated in the next scan using point transform method. The accuracy of each DCT coefficient is normally 12 bits. Assuming short integers are used to represent each DCT coefficient, for a 1600×1200 progressive JPEG coded image with 4:2:2 format, 92,160,000 bits memory space is required for full resolution decoding.

This memory requirement may exceed the physical memory size of some embedded LSI system. Expanding memory capacity makes system costs prohibitively high for progressive JPEG decoding system.

The flexibility of the memory size configuration is needed because various devices for JPEG decoding are available ranging from DVD players/recorders to mobile PDAs. Different decoding systems have different system throughput and memory configurations. The flexible memory and throughput tradeoff decoding method is desired in the progressive JPEG decoding system.

### SUMMARY OF THE INVENTION

In view of the problems mentioned above, it is an objective of the present invention to provide a memory-efficient progressive decoder. In the present invention, the DCT coefficients in a particular decoded scan are classified into to two categories, namely most significant DCT coefficients and least significant DCT coefficients, by using a frequency masking classifier. The least significant DCT coefficients are not stored directly in the memory. They are binarized and represented by either “0” or “1” indicating if they are zero or non-zero coefficients. The binarized bitmap for the least significant DCT coefficients and the actual values of most significant DCT coefficients are stored in the memory and thus, the overall memory requirements are significantly reduced. The memory requirements can be further reduced if we compress the most significant DCT coefficients and bitmap for the least significant DCT coefficients and stored the compressed data. The most significant DCT coefficients are updated in each scan for picture quality refinement and the bitmap of the least significant DCT coefficients is updated to make sure the bitstream pointer are shifted correctly during variable-length decoding process.

In general, the progressive JPEG decoding system comprises a scan and block parser, a multiple-scan resolution refining means, a frequency masking means, a binarization means, a binary sequence compression means, a coefficient compression means, a memory, a binary sequence decompression means, a coefficient decompression means, a variable-length decoding means, an inverse quantization means and an inverse discrete cosine transform means.

The description will now be made on the operation of the progressive decoding system comprising above-described components. The progressive JPEG bitstream is processed by the scan and block parser and a number of decoding parameters including scan number, correction bits and point transform parameter are extracted and passed to a multiple-scan resolution refining means. The parsed bits for each scan are passed to the variable-length decoding means for run-length decoding. A multiple-scan resolution refining means receives the scan number, the point transform parameter, the correction bits, the decoded value and the coefficients of previous scan. It updates the coefficients of previous scan and indicating bitmap of previous scan according to the decoded scan information, including scan number, the point transform parameter and correction bits and generates updated coefficients and non-zero coefficient indicating bits. The frequency masking means defines a masking area in the frequency domain and extracts one or a plurality of updated coefficients to provide coefficients inside the masking area. The binarization means converts updated coefficients and non-zero coefficient indicating bits and represents them using value “0” and “1” for zero coefficients or indicating bits and non-zero coefficients or indicating bits, respectively, to provide indicating bitmap. The binary sequence compression means compresses the indicating bitmap using lossless encoding methods, such as binary entropy encoding, to significantly reduce the number of bits used to represent indicating bitmap and provide the compressed indicating bitmap. The coefficient compression means encodes the coefficient inside the masking area using either lossless and lossy compression algorithms and generates the compressed coefficients. The memory stores the compressed indicating bitmap and compressed coefficients in pre-defined locations and provides compressed coefficients of previous scan and compressed indicating bitmap of previous scan through its output terminals. The binary sequence decompression means decodes the compressed indicating bitmap of previous scan and reconstructs the indicating bitmap of previous scan by using the inverse processing of binary sequence compression means. The coefficient decompression means decodes the compressed coefficients of previous scan by using the inverse processing of lossless and lossy compression algorithms adopted in coefficient compression means to generate coefficients of previous scan. The variable-length decoding means identifies the codeword from one or a plurality of said parsed bits, decoding the identified codeword according to a Huffman coded look-up-table and indicating bitmap of previous scan and provides decoded value. The inverse quantization means scales the coefficients inside the masking area using one or a plurality of quantization scale factors to provide quantized coefficients. The inverse discrete cosine transform means obtains the quantized coefficients inside the masking area and performs a block transform on a block of data comprising said quantized coefficients inside the masking area and “0” values outside the masking area to generate decoded picture.

Although the construction and operations of the progressive JPEG decoding system is briefly described in Section 3.4 and Section 3.5, it is to be noted that various changes and modifications are apparent to those skilled in the art. Such changes and modifications are to be understood as included within the scope of the present invention as defined by the claims unless they depart therefrom.

### BRIEF DESCRIPTION OF THE DRAWINGS

FIG. 1 illustrates a general realization of efficient progressive JPEG picture decoding system.

FIG. 2A illustrates an apparatus for efficient progressive JPEG picture decoding—scheme 1.

FIG. 2B illustrates a frequency masking means for efficient progressive JPEG decoding.

FIG. 3 illustrates an apparatus for efficient progressive JPEG picture decoding—scheme 2.

FIG. 4 illustrates an apparatus for efficient progressive JPEG picture decoding—scheme 3.

FIG. 5 illustrates an apparatus for efficient progressive JPEG picture decoding—scheme 4.

FIG. 6 illustrates an apparatus for efficient progressive JPEG picture decoding—scheme 5.

FIG. 7 illustrates an apparatus for efficient progressive JPEG picture decoding—scheme 6.

FIG. 8 illustrates a variable-length decoding means for progressive JPEG decoding.

FIG. 9 illustrates a multiple-scan resolution refining means for progressive JPEG decoding.

FIG. 10 illustrates a scan approximation means for progressive JPEG decoding.

### DETAILED DESCRIPTION OF THE PREFERRED EMBODIMENTS

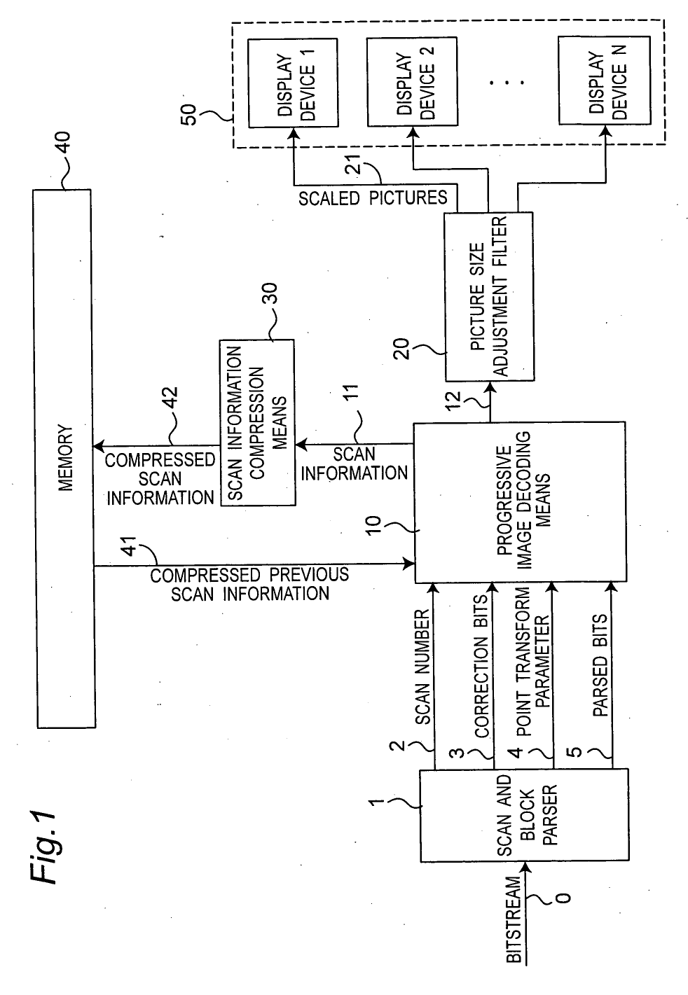

An embodiment of this invention is shown in FIG. 1. This apparatus is used to decode progressive JPEG bitstreams. It comprises a scan and block parser 1, a progressive image decoding means 10, a picture size adjustment filter 20, a scan information compression means 30, a memory 40 and one or a plurality of display devices 50.

The progressive JPEG bitstream is processed by the scan and block parser 1 and a number of decoding parameters including scan number 2, correction bits 3 and point transform parameter 4 are extracted and passed to a progressive decoding means 10. The parsed bits 5 for each scan are also passed to the progressive decoding means 10 for run-length decoding. The progressive decoding means 10 performs run-length decoding and updates the decoded coefficients of each scan based on the scan parameters and compressed previous scan information 41. The scan information 11 for each scan are compressed using the scan information compression means 30 and the compressed scan information 42 are stored into the memory 40. The scan information 11 of the current decoding scan contains useful information for coefficient update in the next scan. The decoded picture 12 is re-scaled to generate various scaled pictures 21 with different sizes for being displayed on various display devices 50.

The effect of the embodiments shown in FIG. 1 is that the progressive JPEG bitstreams can be decoded with much less memory requirements. The bottle-neck of progressive JPEG picture decoding for embedded system with limited memory resources is thus removed. The embodiment shown in FIG. 1 also provides various solutions for storing scan information by fully or partially compressing the intermediate results decoded at each scan. This gives great flexibility of implementation suitable for implementing the present invention for various systems with different complexity and cost requirements.

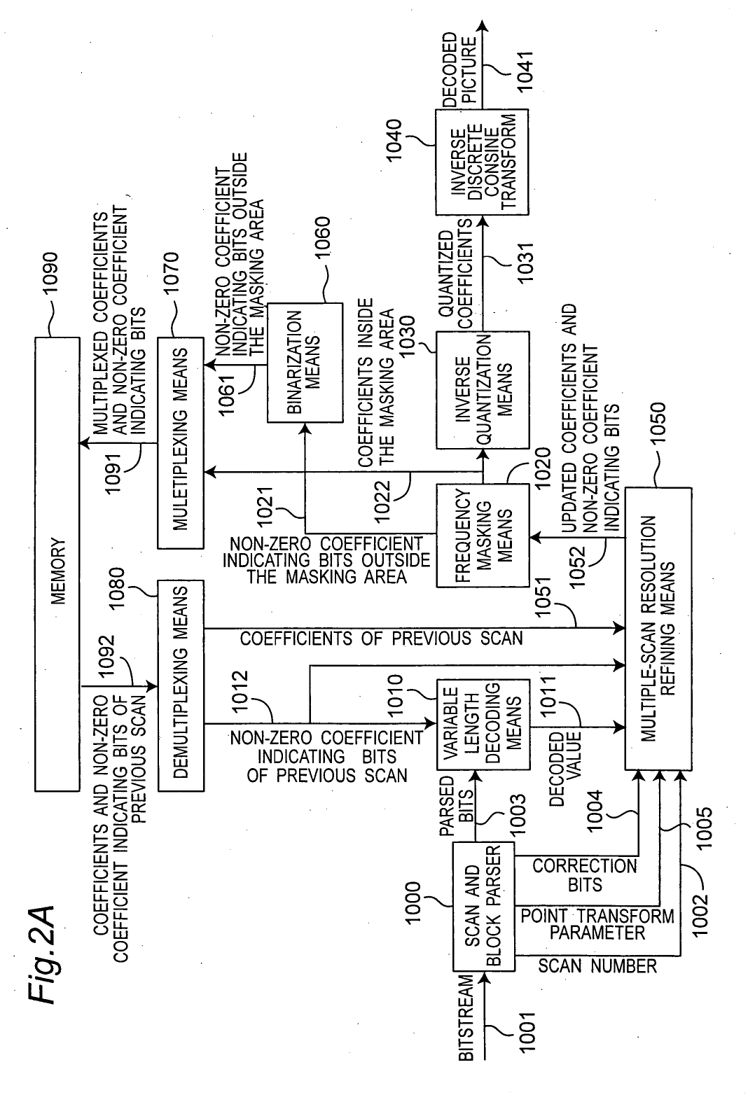

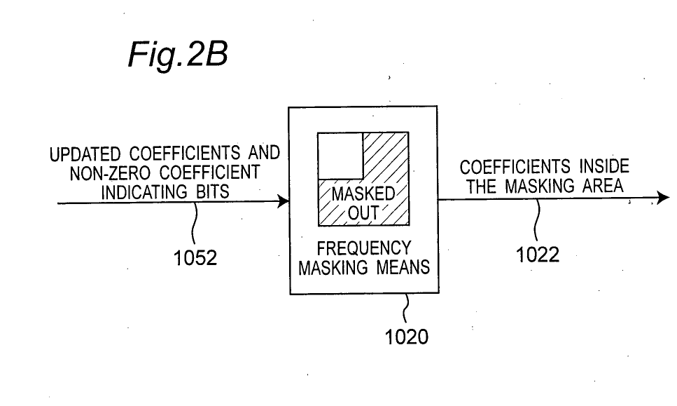

Another embodiment shown in FIG. 2A explains a realization of the progressive image decoding system illustrated in FIG. 1. It comprises a scan and block parser 1000, a multiple-scan resolution refining means 1050, a frequency masking means 1020, a binarization means 1060, a multiplexing means 1070, a memory 1090, a demultiplexing means 1080, a variable-length decoding means 1010, an inverse quantization means 1030 and an inverse discrete cosine transform means 1040.

The operation of this embodiment is now explained. The progressive JPEG bitstream 1001 is processed by the scan and block parser 1000 and a number of decoding parameters including scan number 1002, correction bits 1004 and point transform parameter 1005 are extracted and passed to a multiple-scan resolution refining means 1050. The parsed bits 1003 for each scan are passed to the variable-length decoding means 1010 for run-length decoding. A multiple-scan resolution refining means 1050 receives the scan number 1002, the point transform parameter 1005, the correction bits 1004, the decoded value 1011 and the coefficients of previous scan. It updates the coefficients of previous scan 1051 and non-zero coefficient indicating bits of previous scan 1012 according to the decoded scan information, including scan number 1002, the point transform parameter 1005 and correction bits 1004 and generates updated coefficients and non-zero coefficient indicating bits 1052. The frequency masking means 1020 defines a masking area in the frequency domain and extracts one or a plurality of updated coefficients to provide coefficients inside the masking area 1022 and coefficients or non-zero coefficient indicating bits outside the masking area 1021. The binarization means 1060 converts the coefficients or non-zero indicating bits outside the masking area 1021 and represents them using value “0” and “1” for zero coefficients or indicating bits and non-zero coefficients or indicating bits, respectively. The multiplexing means 1070 combines and re-arranges the coefficients inside the masking area 1022 and non-zero coefficient indicating bits outside the masking area 1061 and provides multiplexed coefficients and non-zero coefficient indicating bits 1091 through its output terminal. The memory 1090 stores the multiplexed coefficients and non-zero coefficient indicating bits 1091 and provides coefficients and non-zero coefficient indicating bits of previous scan 1092 through its output terminal. The demultiplexing means 1080 separates the coefficients and non-zero coefficient indicating bits of previous scan 1092 and provides coefficients of previous scan 1051 and non-zero coefficient indicating bits of previous scan 1012 through its two output terminals. The variable-length decoding means 1010 identifies the codeword from one or a plurality of said parsed bits 1003, decoding the identified codeword according to a Huffman coded look-up-table and non-zero coefficient indicating bits of previous scan 1012 and provides decoded value 1011. The inverse quantization means 1030 scales the coefficients inside the masking area 1022 using one or a plurality of quantization scale factors to provide quantized coefficients 1031. The inverse discrete cosine transform means 1040 obtains the quantized coefficients 1031 inside the masking area and performs a block transform on a block of data comprising said quantized coefficients 1031 inside the masking area and “0” values outside the masking area to generate decoded picture 1041.

Another embodiment shown in FIG. 2B explains a realization of the frequency masking means shown in FIG. 2B through FIG. 7.

The operation of this embodiment is now explained. The frequency masking means 1020 defines a masking area in the frequency domain in each block. One or a plurality of updated coefficients is extracted to provide coefficients inside the masking area 1022.

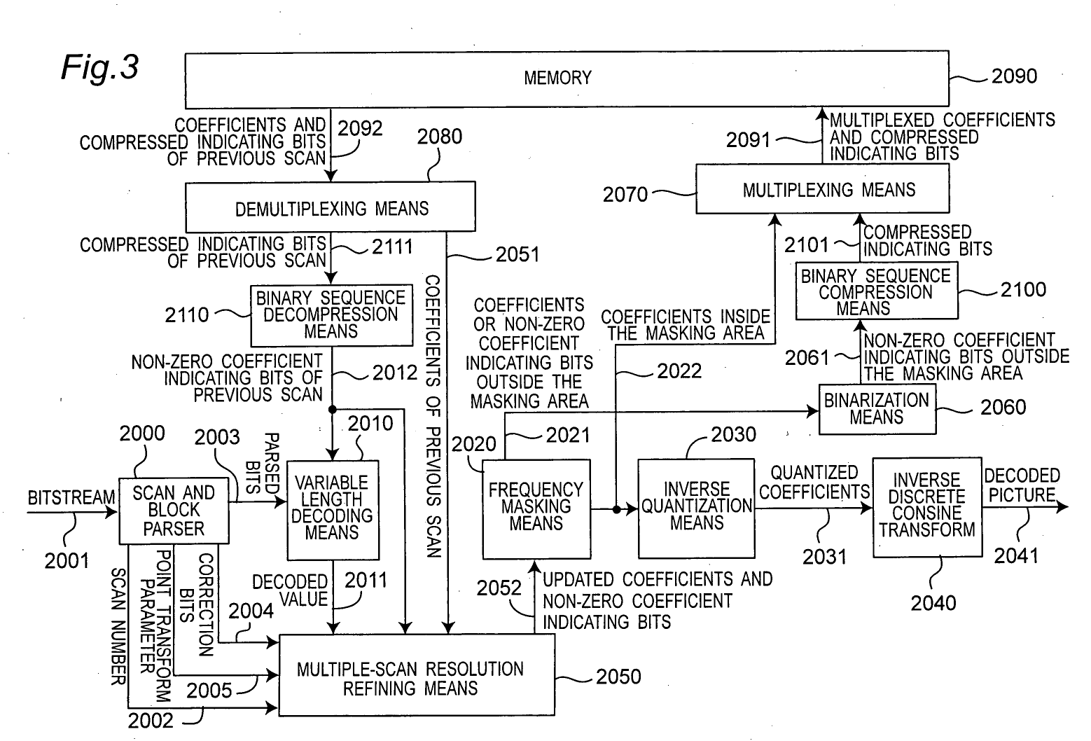

Another embodiment shown in FIG. 3 explains another realization of the progressive image decoding system illustrated in FIG. 1. It comprises a scan and block parser 2000, a multiple-scan resolution refining means 2050, a frequency masking means 2020, a binarization means 2060, a binary sequence compression means 2100, a multiplexing means 2070, a memory 2090, a demultiplexing means 2080, a binary sequence decompression means 2110, a variable-length decoding means 2010, an inverse quantization means 2030 and an inverse discrete cosine transform means 2040.

The operation of this embodiment is now explained. The progressive JPEG bitstream 2001 is processed by the scan and block parser 2000 and a number of decoding parameters including scan number 2002, correction bits 2004 and point transform parameter 2005 are extracted and passed to a multiple-scan resolution refining means 2050. The parsed bits 2003 for each scan are passed to the variable-length decoding means 2010 for run-length decoding. A multiple-scan resolution refining means 2050 receives the scan number 2002, the point transform parameter 2005, the correction bits 2004, the decoded value 2011 and the coefficients of previous scan. It updates the coefficients of previous scan 2051 and non-zero coefficient indicating bits of previous scan 2012 according to the decoded scan information, including scan number 2002, the point transform parameter 2005 and correction bits 2004 and generates updated coefficients and non-zero coefficient indicating bits 2052. The frequency masking means 2020 defines a masking area in the frequency domain and extracts one or a plurality of updated coefficients to provide coefficients inside the masking area 2022 and coefficients or non-zero coefficient indicating bits outside the masking area 2021. The binarization means 2060 converts the coefficients or non-zero indicating bits outside the masking area 2021 and represents them using value “0” and “1” for zero coefficients or indicating bits and non-zero coefficients or indicating bits, respectively. The binary sequence compression means 2100 compresses the non-zero coefficient indicating bits outside the masking area 2061 using lossless encoding methods, such as binary entropy encoding, to significantly reduce the number of bits used to represent the non-zero coefficient indicating bits outside the masking area 2061 and provide the compressed indicating bits 2101. The multiplexing means 2070 combines and re-arranges the coefficients inside the masking area 2022 and compressed indicating bits 2101 and provides multiplexed coefficients and compressed indicating bits 2091 through its output terminal. The memory 2090 stores the multiplexed coefficients and compressed indicating bits 2091 and provides coefficients and compressed indicating bits of previous scan 2092 through its output terminal. The demultiplexing means 2080 separates the coefficients and compressed indicating bits of previous scan 2092 and provides coefficients of previous scan 2051 and compressed indicating bits of previous scan 2111 through its two output terminals. The binary sequence decompression means 2110 decodes the compressed indicating bits of previous scan 2111 and reconstructs the non-zero coefficient indicating bits of previous scan 2012 by using the inverse processing of binary sequence compression means 2100. The variable-length decoding means 2010 identifies the codeword from one or a plurality of said parsed bits 2003, decoding the identified codeword according to a Huffman coded look-up-table and non-zero coefficient indicating bits of previous scan 2012 and provides decoded value 2011. The inverse quantization means 2030 scales the coefficients inside the masking area 2022 using one or a plurality of quantization scale factors to provide quantized coefficients 2031. The inverse discrete cosine transform means 2040 obtains the quantized coefficients 2031 inside the masking area and performs a block transform on a block of data comprising said quantized coefficients 2031 inside the masking area and “0” values outside the masking area to generate decoded picture 2041.

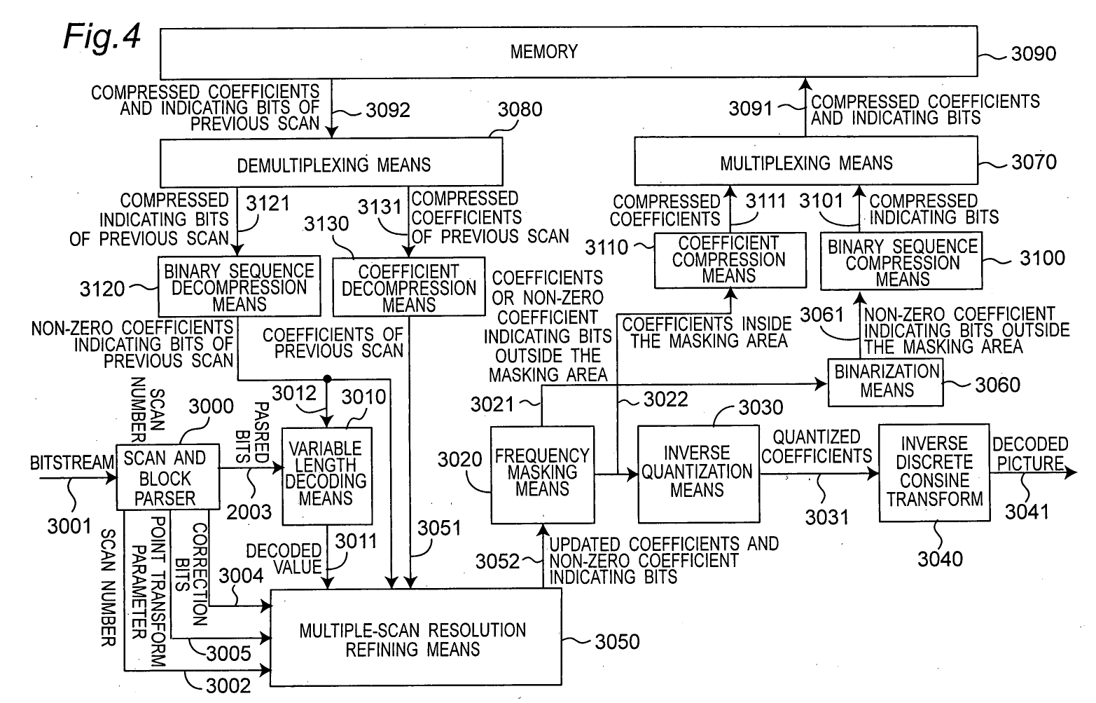

Another embodiment shown in FIG. 4 explains another realization of the progressive image decoding system illustrated in FIG. 1. It comprises a scan and block parser 3000, a multiple-scan resolution refining means 3050, a frequency masking means 3020, a binarization means 3060, a binary sequence compression means 3100, a coefficient compression means 3110, a multiplexing means 3070, a memory 3090, a demultiplexing means 3080, a binary sequence decompression means 3120, a coefficient decompression means 3130, a variable-length decoding means 3010, an inverse quantization means 3030 and an inverse discrete cosine transform means 3040.

The operation of this embodiment is now explained. The progressive JPEG bitstream 3001 is processed by the scan and block parser 3000 and a number of decoding parameters including scan number 3002, correction bits 3004 and point transform parameter 3005 are extracted and passed to a multiple-scan resolution refining means 3050. The parsed bits 3003 for each scan are passed to the variable-length decoding means 3010 for run-length decoding. A multiple-scan resolution refining means 3050 receives the scan number 3002, the point transform parameter 3005, the correction bits 3004, the decoded value 3011 and the coefficients of previous scan. It updates the coefficients of previous scan 3051 and non-zero coefficient indicating bits of previous scan 3012 according to the decoded scan information, including scan number 3002, the point transform parameter 3005 and correction bits 3004 and generates updated coefficients and non-zero coefficient indicating bits 3052. The frequency masking means 3020 defines a masking area in the frequency domain and extracts one or a plurality of updated coefficients to provide coefficients inside the masking area 3022 and coefficients or non-zero coefficient indicating bits outside the masking area 3021. The binarization means 3060 converts the coefficients or non-zero indicating bits outside the masking area 3021 and represents them using value “0” and “1” for zero coefficients or indicating bits and non-zero coefficients or indicating bits, respectively. The binary sequence compression means 3100 compresses the non-zero coefficient indicating bits outside the masking area 3061 using lossless encoding methods, such as binary entropy encoding, to significantly reduce the number of bits used to represent the non-zero coefficient indicating bits outside the masking area 3061 and provide the compressed indicating bits 3101. The coefficient compression means 3110 encodes the coefficient inside the masking area 3022 using either lossless and lossy compression algorithms and generates the compressed coefficients 3111. The multiplexing means 3070 combines and re-arranges the compressed coefficients 3111 and compressed indicating bits 3101 and provides compressed coefficients and indicating bits 3091 through its output terminal. The memory 3090 stores the compressed coefficients and indicating bits 3091 and provides compressed coefficients and indicating bits of previous scan 3092 through its output terminal. The demultiplexing means 3080 separates the compressed coefficients and indicating bits of previous scan 3092 and provides coefficients of previous scan 3051 and compressed indicating bits of previous scan 3121 through its two output terminals. The binary sequence decompression means 3120 decodes the compressed indicating bits of previous scan 3121 and reconstructs the non-zero coefficient indicating bits of previous scan 3012 by using the inverse processing of binary sequence compression means 3100. The coefficient decompression means 3130 decodes the compressed coefficients of previous scan 3131 by using the inverse processing of lossless and lossy compression algorithms adopted in coefficient compression means 3110 to generate coefficients of previous scan 3051. The variable-length decoding means 3010 identifies the codeword from one or a plurality of said parsed bits 3003, decoding the identified codeword according to a Huffman coded look-up-table and non-zero coefficient indicating bits of previous scan 3012 and provides decoded value 3011. The inverse quantization means 3030 scales the coefficients inside the masking area 3022 using one or a plurality of quantization scale factors to provide quantized coefficients 3031. The inverse discrete cosine transform means 3040 obtains the quantized coefficients 3031 inside the masking area and performs a block transform on a block of data comprising said quantized coefficients 3031 inside the masking area and “0” values outside the masking area to generate decoded picture 3041.

The embodiments shown in FIG. 2A through FIG. 4 provide a variety of flexible realizations of progressive JPEG decoding with variable memory capacity configurations. One of the effects of these embodiments is that the memory required for decoding progressive JPEG with fixed resolution defined by the display devices is much smaller than that required for full-size progressive JPEG decoding. Another effects of these embodiments is that even when the display resolution is fixed, the memory requirement can be configured in various ways, giving great decoding flexibilities. For example, if a decoding system operates at very high frequency with small memory capacity, the embodiment shown in FIG. 4 gives better solution compared to those shown in FIG. 2A and FIG. 3. However, if a decoding system operates at very low frequency, or it is designed with low decoding throughput, but its memory capacity is big, the embodiment shown in FIG. 2A is more suitable compared to those shown in FIG. 3 and FIG. 4.

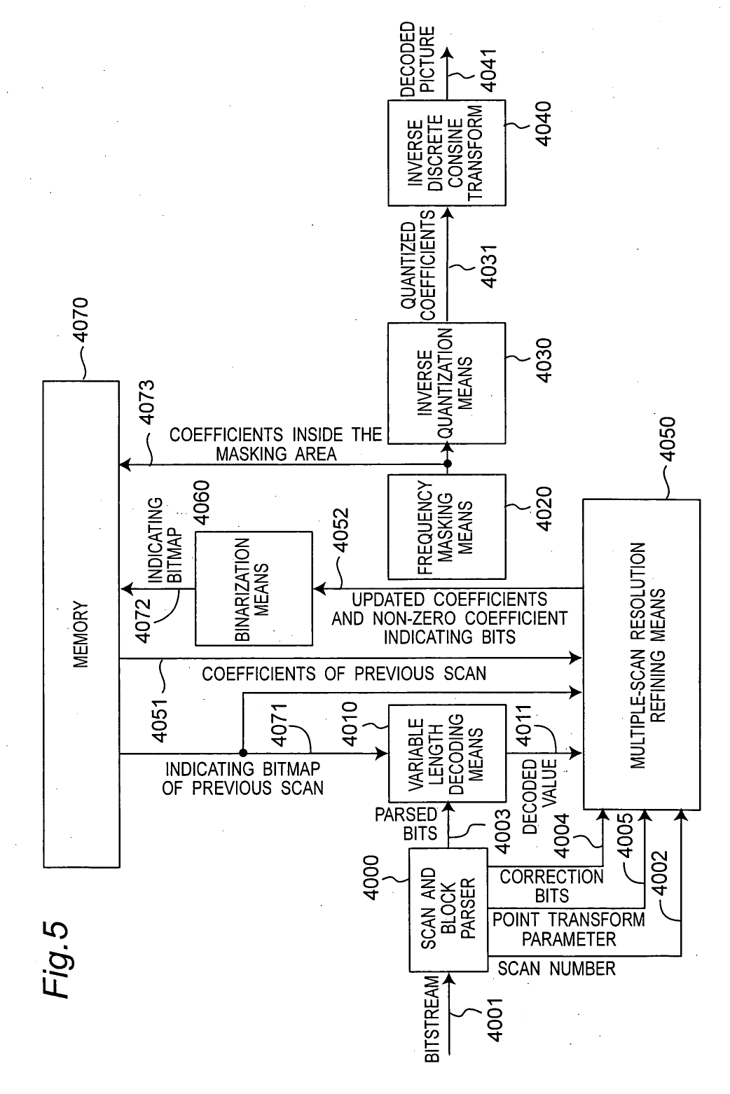

Another embodiment shown in FIG. 5 explains another realization of the progressive image decoding system illustrated in FIG. 1. It comprises a scan and block parser 4000, a multiple-scan resolution refining means 4050, a frequency masking means 4020, a binarization means 4060, a memory 4070, a variable-length decoding means 4010, an inverse quantization means 4030 and an inverse discrete cosine transform means 4040.

The operation of this embodiment is now explained. The progressive JPEG bitstream 4001 is processed by the scan and block parser 4000 and a number of decoding parameters including scan number 4002, correction bits 4004 and point transform parameter 4005 are extracted and passed to a multiple-scan resolution refining means 4050. The parsed bits 4003 for each scan are passed to the variable-length decoding means 4010 for run-length decoding. A multiple-scan resolution refining means 4050 receives the scan number 4002, the point transform parameter 4005, the correction bits 4004, the decoded value 4011 and the coefficients of previous scan. It updates the coefficients of previous scan 4051 and indicating bitmap of previous scan 4071 according to the decoded scan information, including scan number 4002, the point transform parameter 4005 and correction bits 4004 and generates updated coefficients and non-zero coefficient indicating bits 4052. The frequency masking means 4020 defines a masking area in the frequency domain and extracts one or a plurality of updated coefficients to provide coefficients inside the masking area 4073. The binarization means 4060 converts updated coefficients and non-zero coefficient indicating bits 4052 and represents them using value “0” and “1” for zero coefficients or indicating bits and non-zero coefficients or indicating bits, respectively, to provide indicating bitmap 4072. The memory 4070 stores the indicating bitmap and 4072 and coefficients inside the masking area 4073 in pre-defined locations and provides coefficients of previous scan 4051 and indicating bitmap of previous scan 4071 through its output terminals. The variable-length decoding means 4010 identifies the codeword from one or a plurality of said parsed bits 4003, decoding the identified codeword according to a Huffman coded look-up-table and indicating bitmap of previous scan 4071 and provides decoded value 4011. The inverse quantization means 4030 scales the coefficients inside the masking area 4073 using one or a plurality of quantization scale factors to provide quantized coefficients 4031. The inverse discrete cosine transform means 4040 obtains the quantized coefficients 4031 inside the masking area and performs a block transform on a block of data comprising said quantized coefficients 4031 inside the masking area and “0” values outside the masking area to generate decoded picture 4041.

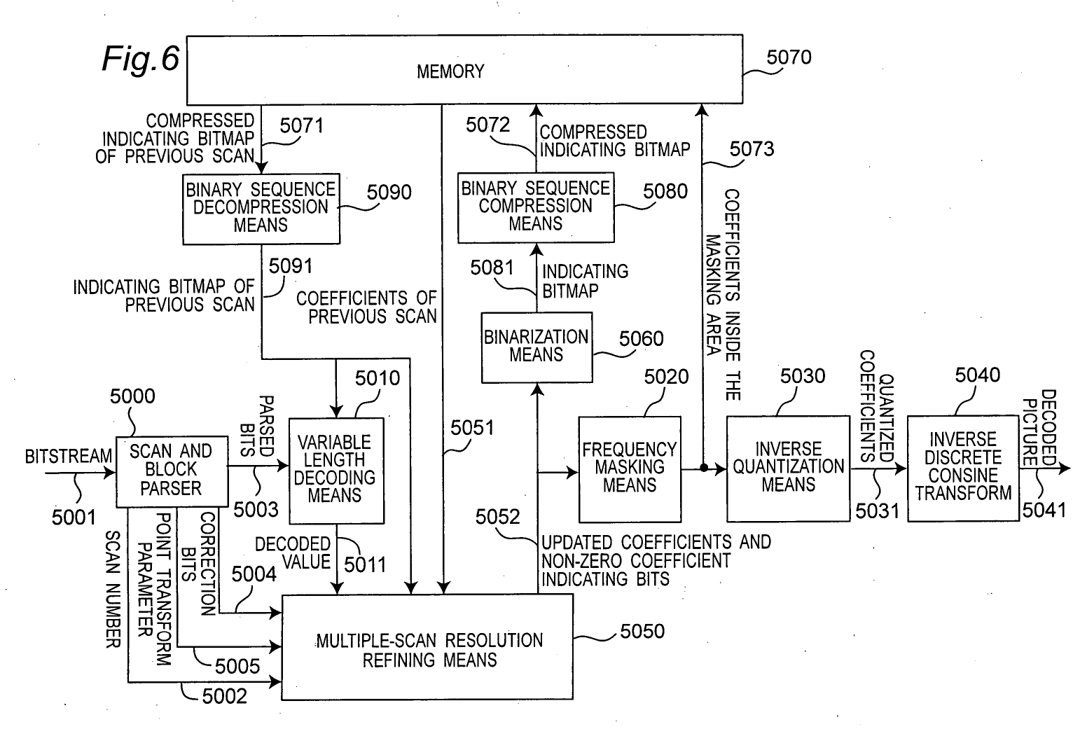

Another embodiment shown in FIG. 6 explains another realization of the progressive image decoding system illustrated in FIG. 1. It comprises a scan and block parser 5000, a multiple-scan resolution refining means 5050, a frequency masking means 5020, a binarization means 5060, a binary sequence compression means 5080, a memory 5070, a binary sequence decompression means 5090, a variable-length decoding means 5010, an inverse quantization means 5030 and an inverse discrete cosine transform means 5040.

The operation of this embodiment is now explained. The progressive JPEG bitstream 5001 is processed by the scan and block parser 5000 and a number of decoding parameters including scan number 5002, correction bits 5004 and point transform parameter 5005 are extracted and passed to a multiple-scan resolution refining means 5050. The parsed bits 5003 for each scan are passed to the variable-length decoding means 5010 for run-length decoding. A multiple-scan resolution refining means 5050 receives the scan number 5002, the point transform parameter 5005, the correction bits 5004, the decoded value 5011 and the coefficients of previous scan. It updates the coefficients of previous scan 5051 and indicating bitmap of previous scan 5071 according to the decoded scan information, including scan number 5002, the point transform parameter 5005 and correction bits 5004 and generates updated coefficients and non-zero coefficient indicating bits 5052. The frequency masking means 5020 defines a masking area in the frequency domain and extracts one or a plurality of updated coefficients to provide coefficients inside the masking area 5073. The binarization means 5060 converts updated coefficients and non-zero coefficient indicating bits 5052 and represents them using value “0” and “1” for zero coefficients or indicating bits and non-zero coefficients or indicating bits, respectively, to provide indicating bitmap 5081. The binary sequence compression means 5080 compresses the indicating bitmap 5081 using lossless encoding methods, such as binary entropy encoding, to significantly reduce the number of bits used to represent indicating bitmap 5081 and provide the compressed indicating bitmap 5072. The memory 5070 stores the compressed indicating bitmap 5072 and coefficients inside the masking area 5073 in pre-defined locations and provides coefficients of previous scan 5051 and compressed indicating bitmap of previous scan 5071 through its output terminals. The binary sequence decompression means 5090 decodes the compressed indicating bitmap of previous scan 5071 and reconstructs the indicating bitmap of previous scan 5091 by using the inverse processing of binary sequence compression means 5080. The variable-length decoding means 5010 identifies the codeword from one or a plurality of said parsed bits 5003, decoding the identified codeword according to a Huffman coded look-up-table and indicating bitmap of previous scan 5091 and provides decoded value 5011. The inverse quantization means 5030 scales the coefficients inside the masking area 5073 using one or a plurality of quantization scale factors to provide quantized coefficients 5031. The inverse discrete cosine transform means 5040 obtains the quantized coefficients 5031 inside the masking area and performs a block transform on a block of data comprising said quantized coefficients 5031 inside the masking area and “0” values outside the masking area to generate decoded picture 5041.

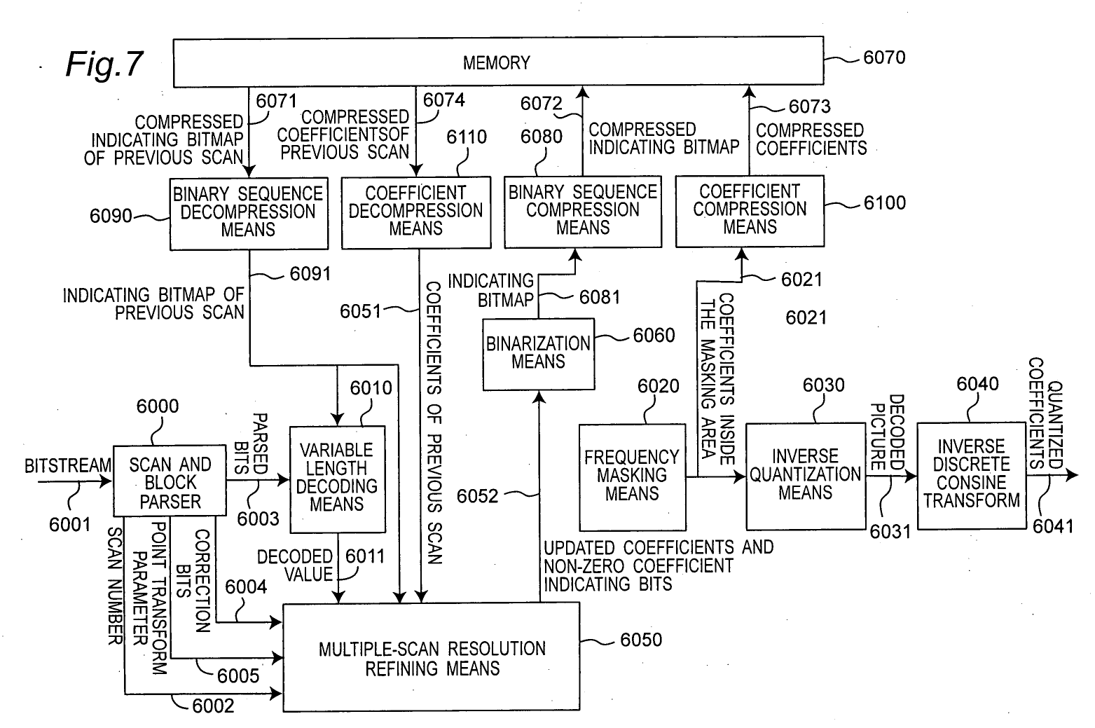

Another embodiment shown in FIG. 7 explains another realization of the progressive image decoding system illustrated in FIG. 1. It comprises a scan and block parser 6000, a multiple-scan resolution refining means 6050, a frequency masking means 6020, a binarization means 6060, a binary sequence compression means 6080, a coefficient compression means 6100, a memory 6070, a binary sequence decompression means 6090, a coefficient decompression means 6110, a variable-length decoding means 6010, an inverse quantization means 6030 and an inverse discrete cosine transform means 6040.

The operation of this embodiment is now explained. The progressive JPEG bitstream 6001 is processed by the scan and block parser 6000 and a number of decoding parameters including scan number 6002, correction bits 6004 and point transform parameter 6005 are extracted and passed to a multiple-scan resolution refining means 6050. The parsed bits 6003 for each scan are passed to the variable-length decoding means 6010 for run-length decoding. A multiple-scan resolution refining means 6050 receives the scan number 6002, the point transform parameter 6005, the correction bits 6004, the decoded value 6011 and the coefficients of previous scan. It updates the coefficients of previous scan 6051 and indicating bitmap of previous scan 6071 according to the decoded scan information, including scan number 6002, the point transform parameter 6005 and correction bits 6004 and generates updated coefficients and non-zero coefficient indicating bits 6052. The frequency masking means 6020 defines a masking area in the frequency domain and extracts one or a plurality of updated coefficients to provide coefficients inside the masking area 6021. The binarization means 6060 converts updated coefficients and non-zero coefficient indicating bits 6052 and represents them using value “0” and “1” for zero coefficients or indicating bits and non-zero coefficients or indicating bits, respectively, to provide indicating bitmap 6081. The binary sequence compression means 6080 compresses the indicating bitmap 6081 using lossless encoding methods, such as binary entropy encoding, to significantly reduce the number of bits used to represent indicating bitmap 6081 and provide the compressed indicating bitmap 6072. The coefficient compression means 6100 encodes the coefficient inside the masking area 6021 using either lossless and lossy compression algorithms and generates the compressed coefficients 6073. The memory 6070 stores the compressed indicating bitmap 6072 and compressed coefficients 6073 in pre-defined locations and provides compressed coefficients of previous scan 6074 and compressed indicating bitmap of previous scan 6071 through its output terminals. The binary sequence decompression means 6090 decodes the compressed indicating bitmap of previous scan 6071 and reconstructs the indicating bitmap of previous scan 6091 by using the inverse processing of binary sequence compression means 6080. The coefficient decompression means 6110 decodes the compressed coefficients of previous scan 6074 by using the inverse processing of lossless and lossy compression algorithms adopted in coefficient compression means 6100 to generate coefficients of previous scan 6051. The variable-length decoding means 6010 identifies the codeword from one or a plurality of said parsed bits 6003, decoding the identified codeword according to a Huffman coded look-up-table and indicating bitmap of previous scan 6091 and provides decoded value 6011. The inverse quantization means 6030 scales the coefficients inside the masking area 6021 using one or a plurality of quantization scale factors to provide quantized coefficients 6031. The inverse discrete cosine transform means 6040 obtains the quantized coefficients 6031 inside the masking area and performs a block transform on a block of data comprising said quantized coefficients 6031 inside the masking area and “0” values outside the masking area to generate decoded picture 6041.

The embodiments shown in FIG. 5 through FIG. 7 is similar to that shown in FIG. 2A through FIG. 4 except that for embodiments shown in FIG. 5 through FIG. 7, the compressed or uncompressed coefficients inside the masking area and the compressed or uncompressed bitmap of every entire block are stored in the memory while for the embodiments shown in FIG. 2A through FIG. 4, the compressed or uncompressed coefficients inside the masking area and the compressed or uncompressed indicating bits out side of the masking area are stored in the memory. The embodiments shown in FIG. 5 through FIG. 7 provide a simple addressing means for memory access while the embodiments illustrated in FIG. 2A through FIG. 4 require a more complicated memory addressing means but a small memory space. Thus the embodiments shown in FIG. 5 through FIG. 7 provide another dimension of implementation flexibility for in terms of the tradeoff between the easiness of memory addressing and size of the memory capacity for storing intermediate decoded results of each scan.

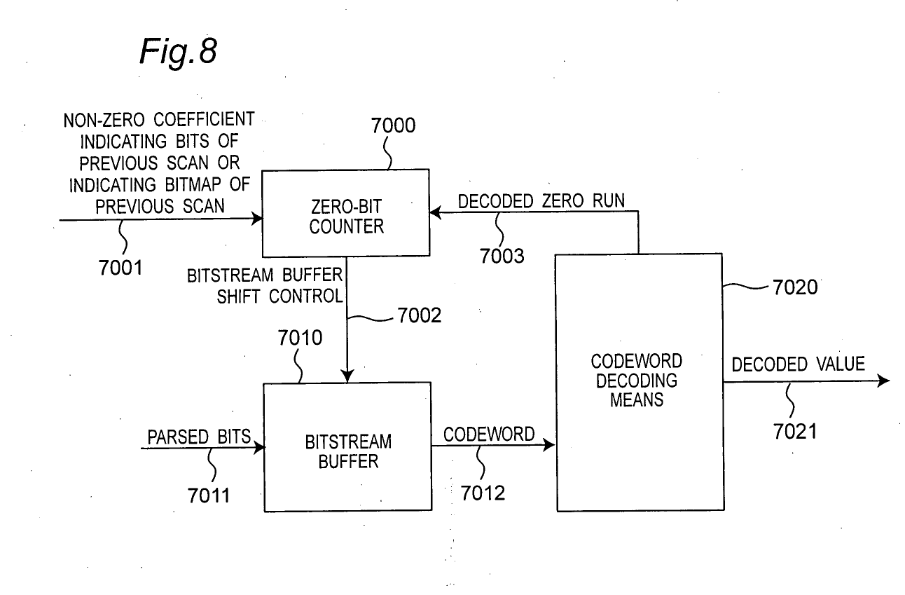

Another embodiment shown in FIG. 8 explains a realization of the variable-length decoding means shown in FIG. 2A through FIG. 7 1010, 2010, 3010, 4010, 5010, 6010. It comprises a zero-bit counter 7000, a bitstream buffer 7010 and a codeword decoding means 7020.

The operation of this embodiment is now explained. The zero-bit counter 7000 uses non-zero coefficient indicating bits of previous scan or indicating bitmap of previous scan 7001 and decoded zero run 7003 to generate bitstream buffer shift control 7002 used to position the parsed bits in bitstream buffer 7010 to the beginning of the next valid codeword. The bitstream buffer 7010 receives and stores one or a plurality of parsed bits 7011 and shifts the parsed bits 7011 according to the bitstream buffer shift control 7002 to form valid codeword 7012 and output the codeword 7012 through its output terminal. The codeword decoding means 7020 decodes the codeword 7012 according to a pre-defined or a pre-downloaded Huffman decoding table, generates decoded zero run 7003 and decoded value 7021 through its two output terminals.

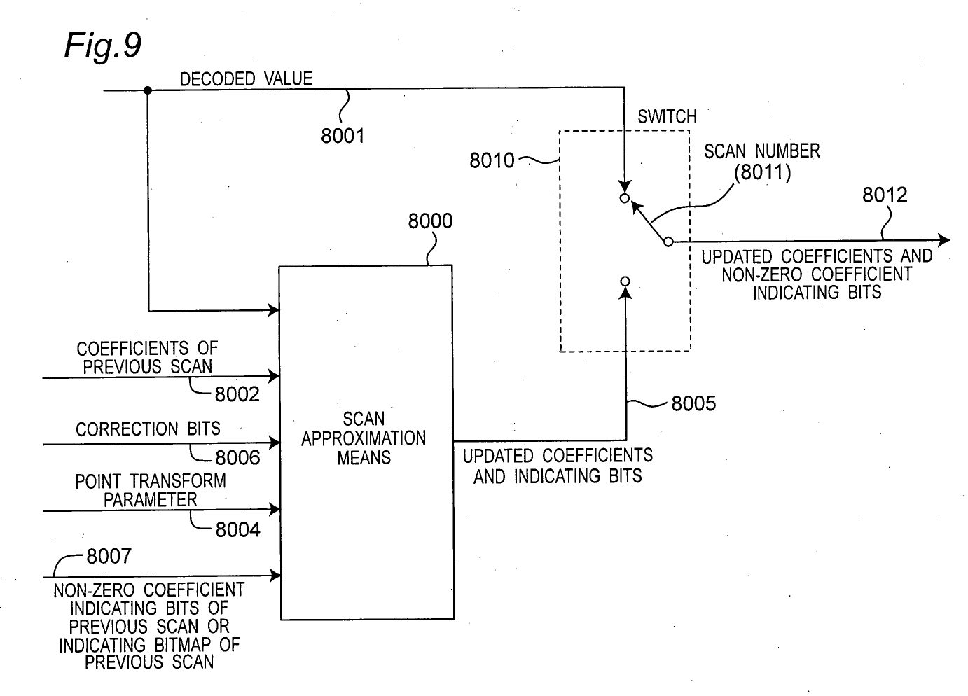

Another embodiment shown in FIG. 9 explains a realization of the multiple-scan resolution refining means shown in FIG. 2A through FIG. 7 1050, 2050, 3050, 4050, 5050, 6050. It comprises a scan approximation means 8000 and a switch 8010.

The operation of this embodiment is now explained. The scan approximation means 8000 refines the coefficients of previous scan 8002 by performing point transform using correction bits 8006 and point transform parameter 8004 and updating non-zero coefficient indicating bits of previous scan or indicating bitmap of previous scan 8007 to provide updated coefficients and indicating bits 8005. The switch 8010 chooses the decoded value 8001 when the scan number 8011 indicates the first scan and chooses the updated coefficients and indicating bits 8005 when the scan number 8011 indicates the subsequent decoding scans to provide updated coefficients and non-zero coefficient indicating bits 8012.

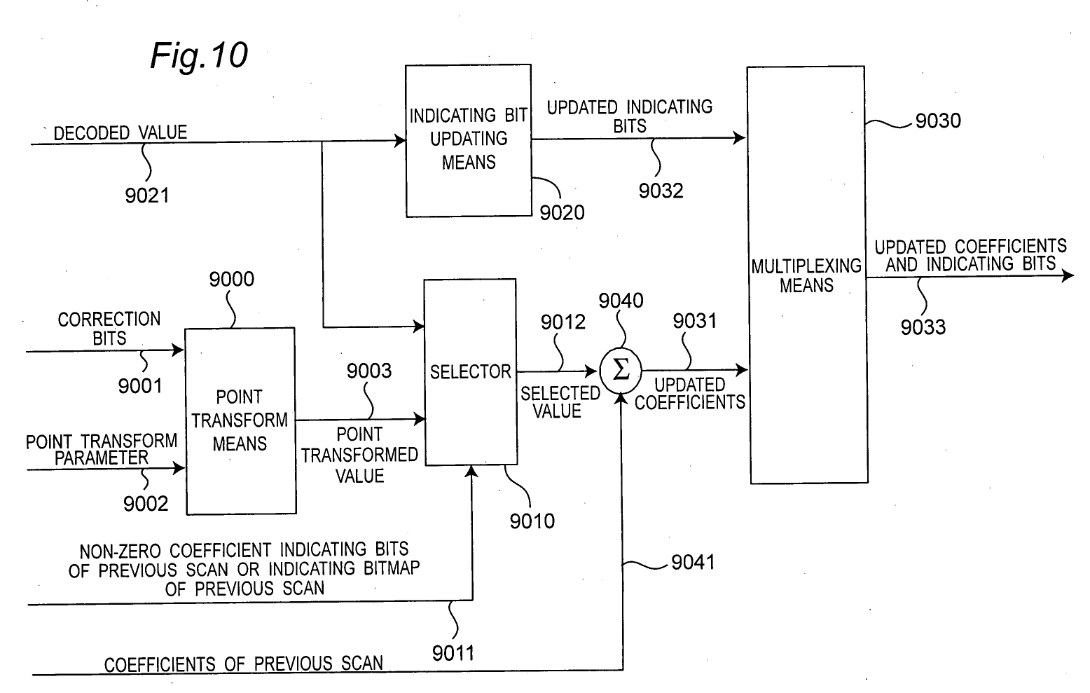

Another embodiment shown in FIG. 10 explains a realization of the scan approximation means shown in FIG. 9 8000. It comprises a point transform means 9000, a selector 9010, a indicating bit updating means 9020 and a multiplexing means 9030.

The operation of this embodiment is now explained. The indicating bit updating means 9020 updates zero-coefficient indicating bit from “0” to “1” if a valid decoded value 9021 is non-zero and keeping zero-coefficient indicating bit as “0” if the valid decoded value 9021 is zero for coefficient outside the masking area. The point transform means 9000 generates point transformed value 9003 by shifting the correction bits 9001 with one of a plurality of number of bits specified by the point transform parameter 9002. The selector 9010 generates selected value 9012 by choosing the decoded value 9021 when the non-zero coefficient indicating bits of previous scan or indicating bitmap of previous scan 9011 receives a “0” and choosing the point transformed value 9003 when the non-zero coefficient indicating bits of previous scan or indicating bitmap of previous scan 9011 receives a “1”. The adding means 9040 sums up the selected value 9012 and the coefficients of previous scan 9041 to generate updated coefficients 9031. The multiplexing means 9030 combines the updated indicating bits 9032 and the updated coefficients 9031 to provide the updated coefficients and indicating bits 9033.

he embodiments shown in FIG. 8 through FIG. 10 are the necessary components for efficient realization of the present invention. These embodiments can be in the various realizations of the present invention shown in FIG. 2A through FIG. 7.

This invention provides a memory-efficient apparatus and method for decoding progressive JPEG bitstreams with minimal memory requirements. Instead of storing all the DCT coefficients of at particular decoding scan, a portion of DCT coefficients and the non-zero coefficient indicators for the rest of the DCT coefficients are stored in either original data format or in a compressed format. The various data storage format provides great implementation flexibility for the system to realize the present invention. The main advantage of the present invention is that the memory requirement for decoding progressive JPEG pictures can be minimized according to the resolution of display devices in the real applications.

The present disclosure relates to subject matter contained in Japanese Application No. 2004-275053, filed on Sep. 22, 2004, the contents of which are herein expressly incorporated by reference in its entirety.

What is claimed is:

1. An apparatus for decoding progressive JPEG image bitstreams, comprising:
a scan and block parser having an input terminal for receiving bitstream and having four output terminals, said scan and block parser for parsing parameters from said bitstream and providing scan number, correction bits and point transform parameter through said four output terminals; and
a progressive image decoding means having a first input terminal for receiving said scan number, a second input terminal for receiving said correction bits, a third input terminal for receiving said point transform parameter, a forth input terminal for receiving said parsed bits and a fifth input terminal for receiving compressed previous scan information and having two output terminals, said progressive image decoding means for decoding said parsed bits, updating said compressed previous scan information based on said scan number, said correction bits and said point transform parameter and providing decoding picture; and
a scan information compression means having an input terminal for receiving said scan information and having an output terminal, said scan information compression means for compressing said scan information using binary or gray-scale data compression techniques and generating compressed scan information; and
a memory having an input terminal for receiving said compressed scan information and having an output terminal, said memory for storing said compressed scan information and providing compressed previous scan information through said output terminal; and
a picture size adjustment filter having an input terminal for receiving decoded picture and having an output terminal, said picture size adjustment filter for scaling the size of said decoded picture and providing scaled pictures for being displayed on display devices for various resolutions; and
one or a plurality of display devices for receiving said scaled pictures and displaying said scaled pictures.

2. An apparatus for decoding progressive JPEG image bitstreams, comprising:
a scan and block parser having an input terminal for receiving bitstream and having four output terminals, said scan and block parser for parsing parameters from said bitstream and providing scan number, correction bits and point transform parameter through said four output terminals; and
a multiple-scan resolution refining means having a first input terminal for receiving said scan number, a second input terminal for receiving said point transform parameter, a third input terminal for receiving said correction bits, a forth input terminal for receiving decoded value, a fifth input terminal for receiving coefficients of previous scan and a sixth input terminal for receiving non-zero coefficient indicating bits of previous scan and an output terminal, said multiple-scan resolution refining means for updating said decoded value and or said coefficients of previous scan based on said scan number, said correction bits and said point transform parameter and providing said updated coefficients and non-zero coefficient indicating bits; and
a frequency masking means having an input terminal for receiving said updated coefficients and non-zero coefficient indicating bits and having two output terminals, said frequency masking means for defining a masking area in the frequency domain and extracting one or a plurality of updated coefficients to provide coefficients inside the masking area and coefficients or non-zero coefficient indicating bits outside the masking area; and
a binarization means having an input terminal for receiving said coefficients or non-zero coefficient indicating bits outside the masking area and having an output terminal, said binarization means for converting said coefficients or non-zero coefficients indicating bits outside the masking area and representing them using value “0” and “1” for zero coefficients or indicating bits and non-zero coefficients or indicating bits, respectively; and
a multiplexing means having a first input terminal for receiving said coefficients inside the masking area and a second input terminal for receiving said non-zero coefficient indicating bits outside the masking area and having an output terminal, said multiplexing means for combining and re-arranging said coefficients inside the masking area and said non-zero coefficient indicating bits outside the masking area and providing multiplexed coefficients and non-zero coefficient indicating bits through its output terminal; and
a memory having an input terminal for receiving said multiplexed coefficients and non-zero coefficient indicating bits and having an output terminal, said memory for storing said multiplexed coefficients and non-zero coefficient indicating bits and providing coefficients and non-zero coefficient indicating bits of previous scan through its output terminal; and
a demultiplexing means having an input terminal for receiving said coefficients and non-zero coefficient indicating bits of previous scan and having two output terminals, said demultiplexing means for separating said coefficients and non-zero coefficient indicating bits of previous scan and providing coefficients of previous scan and non-zero coefficient indicating bits of previous scan through its two output terminals; and
a variable-length decoding means having a first input terminal for receiving said non-zero coefficient indicating bits of previous scan and a second input terminal for receiving said parsed bits and having an output terminal, said variable-length decoding means for identifying the codeword from one or a plurality of said parsed bits, decoding said codeword according to a Huffman coded look-up-table and non-zero coefficient indicating bits of previous scan and providing decoded value; and
an inverse quantization means having an input terminal for receiving said coefficients inside the masking area and having an output terminal, said inverse quantization means for scaling said coefficients inside the masking area using one or a plurality of quantization scale factors to provide quantized coefficients; and
an inverse discrete cosine transform means having an input terminal for receiving said quantized coefficients and having an output terminal, said inverse discrete cosine transform means for obtaining said quantized coefficients inside the masking area and performing a block transform on a block of data comprising said quantized coefficients inside the masking area and “0” values outside the masking area to generate decoded pictures.

3. An apparatus for decoding progressive JPEG image bitstreams, comprising:
a scan and block parser having an input terminal for receiving bitstream and having four output terminals, said scan and block parser for parsing parameters from said bitstream and providing scan number, correction bits and point transform parameter through said four output terminals; and
a multiple-scan resolution refining means having a first input terminal for receiving said scan number, a second input terminal for receiving said point transform parameter, a third input terminal for receiving said correction bits, a forth input terminal for receiving decoded value, a fifth input terminal for receiving coefficients of previous scan and a sixth input terminal for receiving non-zero coefficient indicating bits of previous scan and an output terminal, said multiple-scan resolution refining means for updating said decoded value and or said coefficients of previous scan based on said scan number, said correction bits and said point transform parameter and providing said updated coefficients and non-zero coefficient indicating bits; and
a frequency masking means having an input terminal for receiving said updated coefficients and non-zero coefficient indicating bits and having two output terminals, said frequency masking means for defining a masking area in the frequency domain and extracting one or a plurality of updated coefficients to provide coefficients inside the masking area and coefficients or non-zero coefficient indicating bits outside the masking area; and
a binarization means having an input terminal for receiving said coefficients or non-zero coefficient indicating bits outside the masking area and having an output terminal, said binarization means for converting said coefficients or non-zero coefficients indicating bits outside the masking area and representing them using value “0” and “1” for zero coefficients or indicating bits and non-zero coefficients or indicating bits, respectively; and
a binary sequence compression means having an input terminal for receiving said non-zero coefficients indicating bits outside the masking area and having an output terminal, said binary sequence compression means for compressing its input binary sequences using lossless compression methods and providing compressed indicating bits through its output terminal; and
a multiplexing means having a first input terminal for receiving said coefficients inside the masking area and a second input terminal for receiving said compressed indicating bits and having an output terminal, said multiplexing means for combining and re-arranging said coefficients inside the masking area and said compressed indicating bits and providing multiplexed coefficients and compressed indicating bits through its output terminal; and
a memory having an input terminal for receiving said multiplexed coefficients and compressed indicating bits and having an output terminal, said memory for storing said multiplexed coefficients and compressed indicating bits and providing coefficients and compressed indicating bits of previous scan through its output terminal; and
a demultiplexing means having an input terminal for receiving said coefficients and compressed indicating bits of previous scan and having two output terminals, said demultiplexing means for separating said coefficients and compressed indicating bits of previous scan and providing coefficients of previous scan and compressed indicating bits of previous scan through its two output terminals; and
a binary sequence decompression means having an input terminal for receiving said compressed indicating bits of previous scan and having an output terminal, said binary sequence decompression means for decoding said compressed indicating bits of previous scan, reconstructing said non-zero coefficient indicating bit outside of the masking area in previous scan and providing non-zero coefficient indicating bits of previous scan; and
a variable-length decoding means having a first input terminal for receiving said non-zero coefficient indicating bits of previous scan and a second input terminal for receiving said parsed bits and having an output terminal, said variable-length decoding means for identifying the codeword from one or a plurality of said parsed bits, decoding said codeword according to a Huffman coded look-up-table and said non-zero coefficient indicating bits of previous scan and providing decoded value; and
an inverse quantization means having an input terminal for receiving said coefficients inside the masking area and having an output terminal, said inverse quantization means for scaling said coefficients inside the masking area using one or a plurality of quantization scale factors to provide quantized coefficients; and
an inverse discrete cosine transform means having an input terminal for receiving said quantized coefficients and having an output terminal, said inverse discrete cosine transform means for obtaining said quantized coefficients inside the masking area and performing a block transform on a block of data comprising said quantized coefficients inside the masking area and “0” values outside the masking area to generate decoded pictures.

4. An apparatus for decoding progressive JPEG image bitstreams, comprising:
a scan and block parser having an input terminal for receiving bitstream and having four output terminals, said scan and block parser for parsing parameters from said bitstream and providing scan number, correction bits and point transform parameter through said four output terminals; and
a multiple-scan resolution refining means having a first input terminal for receiving said scan number, a second input terminal for receiving said point transform parameter, a third input terminal for receiving said correction bits, a forth input terminal for receiving decoded value, a fifth input terminal for receiving coefficients of previous scan and a sixth input terminal for receiving non-zero coefficient indicating bits of previous scan and an output terminal, said multiple-scan resolution refining means for updating said decoded value and or said coefficients of previous scan based on said scan number, said correction bits and said point transform parameter and providing said updated coefficients and non-zero coefficient indicating bits; and
a frequency masking means having an input terminal for receiving said updated coefficients and non-zero coefficient indicating bits and having two output terminals, said frequency masking means for defining a masking area in the frequency domain and extracting one or a plurality of updated coefficients to provide coefficients inside the masking area and coefficients or non-zero coefficient indicating bits outside the masking area; and
a binarization means having an input terminal for receiving said coefficients or non-zero coefficient indicating bits outside the masking area and having an output terminal, said binarization means for converting said coefficients or non-zero coefficients indicating bits outside the masking area and representing them using value “0” and “1” for zero coefficients or indicating bits and non-zero coefficients or indicating bits, respectively; and
a binary sequence compression means having an input terminal for receiving said non-zero coefficients indicating bits outside the masking area and having an output terminal, said binary sequence compression means for compressing its input binary sequences using lossless compression methods and providing compressed indicating bits through its output terminal; and
a coefficient compression means having an input terminal for receiving said coefficients inside the masking area and having an output terminal, said coefficient compression means for compressing said coefficients inside the masking area, in either lossy or lossless coding method, and providing compressed coefficient; and
a multiplexing means having a first input terminal for receiving said compressed coefficients and a second input terminal for receiving said compressed indicating bits and having an output terminal, said multiplexing means for combining and re-arranging said compressed coefficients and said compressed indicating bits and providing compressed coefficients and indicating bits through its output terminal; and
a memory having an input terminal for receiving said compressed coefficients and indicating bits and having an output terminal, said memory for storing said compressed coefficients and indicating bits and providing compressed coefficients and indicating bits of previous scan through its output terminal; and
a demultiplexing means having an input terminal for receiving said compressed coefficients and indicating bits of previous scan and having two output terminals, said demultiplexing means for separating said compressed coefficients and indicating bits of previous scan and providing compressed coefficients of previous scan and compressed indicating bits of previous scan through its two output terminals; and
a binary sequence decompression means having an input terminal for receiving said compressed indicating bits of previous scan and having an output terminal, said binary sequence decompression means for decoding said compressed indicating bits of previous scan, reconstructing said non-zero coefficient indicating bit outside of the masking area in previous scan and providing non-zero coefficient indicating bits of previous scan; and
a coefficient decompression means having an input terminal for receiving said compressed coefficients of previous scan and having an output terminal, said coefficient decompression means for decoding said compressed coefficients of previous scan, reconstructing coefficients inside the masking area in previous scan and providing coefficients of previous scan; and
a variable-length decoding means having a first input terminal for receiving said non-zero coefficient indicating bits of previous scan and a second input terminal for receiving said parsed bits and having an output terminal, said variable-length decoding means for identifying the codeword from one or a plurality of said parsed bits, decoding said codeword according to a Huffman coded look-up-table and non-zero coefficient indicating bits of previous scan and providing decoded value; and
an inverse quantization means having an input terminal for receiving said coefficients inside the masking area and having an output terminal, said inverse quantization means for scaling said coefficients inside the masking area using one or a plurality of quantization scale factors to provide quantized coefficients; and
an inverse discrete cosine transform means having an input terminal for receiving said quantized coefficients and having an output terminal, said inverse discrete cosine transform means for obtaining said quantized coefficients inside the masking area and performing a block transform on a block of data comprising said quantized coefficients inside the masking area and “0” values outside the masking area to generate decoded pictures.

5. An apparatus for decoding progressive JPEG image bitstreams, comprising:
a scan and block parser having an input terminal for receiving bitstream and having four output terminals, said scan and block parser for parsing parameters from said bitstream and providing scan number, correction bits and point transform parameter through said four output terminals; and
a multiple-scan resolution refining means having a first input terminal for receiving said scan number, a second input terminal for receiving said point transform parameter, a third input terminal for receiving said correction bits, a forth input terminal for receiving decoded value, a fifth input terminal for receiving coefficient of previous scan and a sixth input terminal for receiving indicating bitmap of previous scan and an output terminal, said multiple-scan resolution refining means for updating said decoded value and or said coefficients of previous scan based on said scan number, said correction bits and said point transform parameter and providing said updated coefficients and non-zero coefficient indicating bits; and
a frequency masking means having an input terminal for receiving said updated coefficients and non-zero coefficient indicating bits and having an output terminals, said frequency masking means for defining a masking area in the frequency domain and extracting one or a plurality of updated coefficients to provide coefficients inside the masking area; and
a binarization means having an input terminal for receiving said updated coefficients and non-zero coefficient indicating bits, said binarization means for converting said updated coefficients and non-zero coefficient indicating bits, representing them using value “0” and “1” for zero coefficients or indicating bits and non-zero coefficients or indicating bits, respectively, and providing indicating bitmap; and
a memory having a first input terminal for receiving said coefficient inside the masking area and a second input terminal for receiving said indicating bitmap and having two output terminals, said memory for storing said coefficients inside the masking area and said indicating bitmap in pre-defined locations and providing coefficient of previous scan and indicating bitmap of previous scan through its two output terminals; and
a variable-length decoding means having a first input terminal for receiving said indicating bitmap of previous scan and a second input terminal for receiving said parsed bits and having an output terminal, said variable-length decoding means for identifying the codeword from one or a plurality of said parsed bits, decoding said codeword according to a Huffman coded look-up-table and said indicating bitmap of previous scan and providing decoded value; and
an inverse quantization means having an input terminal for receiving said coefficients inside the masking area and having an output terminal, said inverse quantization means for scaling said coefficients inside the masking area using one or a plurality of quantization scale factors to provide quantized coefficients; and
an inverse discrete cosine transform means having an input terminal for receiving said quantized coefficients and having an output terminal, said inverse discrete cosine transform means for obtaining said quantized coefficients inside the masking area and performing a block transform on a block of data comprising said quantized coefficients inside the masking area and “0” values outside the masking area to generate decoded pictures.

6. An apparatus for decoding progressive JPEG image bitstreams, comprising:
a scan and block parser having an input terminal for receiving bitstream and having four output terminals, said scan and block parser for parsing parameters from said bitstream and providing scan number, correction bits and point transform parameter through said four output terminals; and
a multiple-scan resolution refining means having a first input terminal for receiving said scan number, a second input terminal for receiving said point transform parameter, a third input terminal for receiving said correction bits, a forth input terminal for receiving decoded value, a fifth input terminal for receiving coefficient of previous scan and a sixth input terminal for receiving indicating bitmap of previous scan and an output terminal, said multiple-scan resolution refining means for updating said decoded value and or said coefficients of previous scan based on said scan number, said correction bits and said point transform parameter and providing said updated coefficients and non-zero coefficient indicating bits; and
a frequency masking means having an input terminal for receiving said updated coefficients and non-zero coefficient indicating bits and having an output terminals, said frequency masking means for defining a masking area in the frequency domain and extracting one or a plurality of updated coefficients to provide coefficients inside the masking area; and
a binarization means having an input terminal for receiving said updated coefficients and non-zero coefficient indicating bits, said binarization means for converting said updated coefficients and non-zero coefficient indicating bits, representing them using value “0” and “1” for zero coefficients or indicating bits and non-zero coefficients or indicating bits, respectively, and providing indicating bitmap; and
a binary sequence compression means having an input terminal for receiving said indicating bitmap and having an output terminal, said binary sequence compression means for compressing its input binary sequences using lossless compression methods and providing compressed indicating bitmap through its output terminal; and
a memory having a first input terminal for receiving said coefficient inside the masking area and a second input terminal for receiving said compressed indicating bitmap and having two output terminals, said memory for storing said coefficients inside the masking area and said compressed indicating bitmap in pre-defined locations and providing coefficient of previous scan and compressed indicating bitmap of previous scan through its two output terminals; and
a binary sequence decompression means having an input terminal for receiving said compressed indicating bitmap of previous scan and having an output terminal, said binary sequence decompression means for decoding said compressed indicating bitmap of previous scan, reconstructing said non-zero coefficient indicating bitmap in previous scan and providing indicating bitmap of previous scan; and
a variable-length decoding means having a first input terminal for receiving said indicating bitmap of previous scan and a second input terminal for receiving said parsed bits and having an output terminal, said variable-length decoding means for identifying the codeword from one or a plurality of said parsed bits, decoding said codeword according to a Huffman coded look-up-table and said indicating bitmap of previous scan and providing decoded value; and
an inverse quantization means having an input terminal for receiving said coefficients inside the masking area and having an output terminal, said inverse quantization means for scaling said coefficients inside the masking area using one or a plurality of quantization scale factors to provide quantized coefficients; and
an inverse discrete cosine transform means having an input terminal for receiving said quantized coefficients and having an output terminal, said inverse discrete cosine transform means for obtaining said quantized coefficients inside the masking area and performing a block transform on a block of data comprising said quantized coefficients inside the masking area and “0” values outside the masking area to generate decoded pictures.

7. An apparatus for decoding progressive JPEG image bitstreams, comprising:
a scan and block parser having an input terminal for receiving bitstream and having four output terminals, said scan and block parser for parsing parameters from said bitstream and providing scan number, correction bits and point transform parameter through said four output terminals; and
a multiple-scan resolution refining means having a first input terminal for receiving said scan number, a second input terminal for receiving said point transform parameter, a third input terminal for receiving said correction bits, a forth input terminal for receiving decoded value, a fifth input terminal for receiving coefficient of previous scan and a sixth input terminal for receiving indicating bitmap of previous scan and an output terminal, said multiple-scan resolution refining means for updating said decoded value and or said coefficients of previous scan based on said scan number, said correction bits and said point transform parameter and providing said updated coefficients and non-zero coefficient indicating bits; and
a frequency masking means having an input terminal for receiving said updated coefficients and non-zero coefficient indicating bits and having an output terminals, said frequency masking means for defining a masking area in the frequency domain and extracting one or a plurality of updated coefficients to provide coefficients inside the masking area; and
a binarization means having an input terminal for receiving said updated coefficients and non-zero coefficient indicating bits, said binarization means for converting said updated coefficients and non-zero coefficient indicating bits, representing them using value “0” and “1” for zero coefficients or indicating bits and non-zero coefficients or indicating bits, respectively, and providing indicating bitmap; and
a binary sequence compression means having an input terminal for receiving said indicating bitmap and having an output terminal, said binary sequence compression means for compressing its input binary sequences using lossless compression methods and providing compressed indicating bitmap through its output terminal; and
a coefficient compression means having an input terminal for receiving said coefficients inside the masking area and having an output terminal, said coefficient compression means for compressing said coefficients inside the masking area, in either lossy or lossless coding method, and providing compressed coefficient; and
a memory having a first input terminal for receiving said compressed coefficient and a second input terminal for receiving said compressed indicating bitmap and having two output terminals, said memory for storing said compressed coefficients and said compressed indicating bitmap in pre-defined locations and providing compressed coefficient of previous scan and compressed indicating bitmap of previous scan through its two output terminals; and
a binary sequence decompression means having an input terminal for receiving said compressed indicating bitmap of previous scan and having an output terminal, said binary sequence decompression means for decoding said compressed indicating bitmap of previous scan, reconstructing said non-zero coefficient indicating bitmap in previous scan and providing indicating bitmap of previous scan; and
a coefficient decompression means having an input terminal for receiving said compressed coefficients of previous scan and having an output terminal, said coefficient decompression means for decoding said compressed coefficients of previous scan, reconstructing coefficients inside the masking area in previous scan and providing coefficients of previous scan; and
a variable-length decoding means having a first input terminal for receiving said indicating bitmap of previous scan and a second input terminal for receiving said parsed bits and having an output terminal, said variable-length decoding means for identifying the codeword from one or a plurality of said parsed bits, decoding said codeword according to a Huffman coded look-up-table and said indicating bitmap of previous scan and providing decoded value; and
an inverse quantization means having an input terminal for receiving said coefficients inside the masking area and having an output terminal, said inverse quantization means for scaling said coefficients inside the masking area using one or a plurality of quantization scale factors to provide quantized coefficients; and
an inverse discrete cosine transform means having an input terminal for receiving said quantized coefficients and having an output terminal, said inverse discrete cosine transform means for obtaining said quantized coefficients inside the masking area and performing a block transform on a block of data comprising said quantized coefficients inside the masking area and “0” values outside the masking area to generate decoded pictures.

8. The apparatus set forth in claim 2 wherein said variable-length decoding means comprises:
a zero-bit counter having a first input terminal for receiving non-zero coefficient indicating bits of previous scan or indicating bitmap of previous scan and second input terminal for receiving decoded zero run and having output terminal, said zero-bit counter for generating bitstream buffer shift control from said non-zero coefficient indicating bits of previous scan or indicating bitmap of previous scan and decoded zero run through said output terminal;
a bitstream buffer having a first input terminal for receiving one or a plurality of said parsed bits and second input terminal for receiving bitstream buffer shift control and having an output terminal, said bitstream buffer for receiving and storing one or a plurality of said parsed bits and shifting said parsed bits according to said bitstream buffer shift control to form valid codeword and output said codeword through its output terminal; and
a codeword decoding means having an input terminal for receiving said codeword and having two output terminals, said codeword decoding means for decoding said codeword according to a pre-defined or a pre-downloaded Huffman decoding table, generating and providing decoded zero run and decoded value through its two output terminals.

9. The apparatus set forth in claim 3 wherein said variable-length decoding means comprises:
a zero-bit counter having a first input terminal for receiving non-zero coefficient indicating bits of previous scan or indicating bitmap of previous scan and second input terminal for receiving decoded zero run and having output terminal, said zero-bit counter for generating bitstream buffer shift control from said non-zero coefficient indicating bits of previous scan or indicating bitmap of previous scan and decoded zero run through said output terminal;
a bitstream buffer having a first input terminal for receiving one or a plurality of said parsed bits and second input terminal for receiving bitstream buffer shift control and having an output terminal, said bitstream buffer for receiving and storing one or a plurality of said parsed bits and shifting said parsed bits according to said bitstream buffer shift control to form valid codeword and output said codeword through its output terminal; and
a codeword decoding means having an input terminal for receiving said codeword and having two output terminals, said codeword decoding means for decoding said codeword according to a pre-defined or a pre-downloaded Huffman decoding table, generating and providing decoded zero run and decoded value through its two output terminals.

10. The apparatus set forth in claim 4 wherein said variable-length decoding means comprises:
a zero-bit counter having a first input terminal for receiving non-zero coefficient indicating bits of previous scan or indicating bitmap of previous scan and second input terminal for receiving decoded zero run and having output terminal, said zero-bit counter for generating bitstream buffer shift control from said non-zero coefficient indicating bits of previous scan or indicating bitmap of previous scan and decoded zero run through said output terminal;
a bitstream buffer having a first input terminal for receiving one or a plurality of said parsed bits and second input terminal for receiving bitstream buffer shift control and having an output terminal, said bitstream buffer for receiving and storing one or a plurality of said parsed bits and shifting said parsed bits according to said bitstream buffer shift control to form valid codeword and output said codeword through its output terminal; and
a codeword decoding means having an input terminal for receiving said codeword and having two output terminals, said codeword decoding means for decoding said codeword according to a pre-defined or a pre-downloaded Huffman decoding table, generating and providing decoded zero run and decoded value through its two output terminals.

11. The apparatus set forth in claim 5 wherein said variable-length decoding means comprises:
a zero-bit counter having a first input terminal for receiving non-zero coefficient indicating bits of previous scan or indicating bitmap of previous scan and second input terminal for receiving decoded zero run and having output terminal, said zero-bit counter for generating bitstream buffer shift control from said non-zero coefficient indicating bits of previous scan or indicating bitmap of previous scan and decoded zero run through said output terminal;
a bitstream buffer having a first input terminal for receiving one or a plurality of said parsed bits and second input terminal for receiving bitstream buffer shift control and having an output terminal, said bitstream buffer for receiving and storing one or a plurality of said parsed bits and shifting said parsed bits according to said bitstream buffer shift control to form valid codeword and output said codeword through its output terminal; and
a codeword decoding means having an input terminal for receiving said codeword and having two output terminals, said codeword decoding means for decoding said codeword according to a pre-defined or a pre-downloaded Huffman decoding table, generating and providing decoded zero run and decoded value through its two output terminals.

12. The apparatus set forth in claim 6 wherein said variable-length decoding means comprises:
a zero-bit counter having a first input terminal for receiving non-zero coefficient indicating bits of previous scan or indicating bitmap of previous scan and second input terminal for receiving decoded zero run and having output terminal, said zero-bit counter for generating bitstream buffer shift control from said non-zero coefficient indicating bits of previous scan or indicating bitmap of previous scan and decoded zero run through said output terminal;
a bitstream buffer having a first input terminal for receiving one or a plurality of said parsed bits and second input terminal for receiving bitstream buffer shift control and having an output terminal, said bitstream buffer for receiving and storing one or a plurality of said parsed bits and shifting said parsed bits according to said bitstream buffer shift control to form valid codeword and output said codeword through its output terminal; and
a codeword decoding means having an input terminal for receiving said codeword and having two output terminals, said codeword decoding means for decoding said codeword according to a pre-defined or a pre-downloaded Huffman decoding table, generating and providing decoded zero run and decoded value through its two output terminals.

13. The apparatus set forth in claim 7 wherein said variable-length decoding means comprises:
a zero-bit counter having a first input terminal for receiving non-zero coefficient indicating bits of previous scan or indicating bitmap of previous scan and second input terminal for receiving decoded zero run and having output terminal, said zero-bit counter for generating bitstream buffer shift control from said non-zero coefficient indicating bits of previous scan or indicating bitmap of previous scan and decoded zero run through said output terminal.
a bitstream buffer having a first input terminal for receiving one or a plurality of said parsed bits and second input terminal for receiving bitstream buffer shift control and having an output terminal, said bitstream buffer for receiving and storing one or a plurality of said parsed bits and shifting said parsed bits according to said bitstream buffer shift control to form valid codeword and output said codeword through its output terminal; and
a codeword decoding means having an input terminal for receiving said codeword and having two output terminals, said codeword decoding means for decoding said codeword according to a pre-defined or a pre-downloaded Huffman decoding table, generating and providing decoded zero run and decoded value through its two output terminals.

14. The apparatus set forth in claim 2 wherein said multiple-scan resolution refining means comprises:
a scan approximation means having a first input terminal for receiving said coefficients of previous scan, a second input terminal for receiving said correction bits, a third input terminal for receiving said point transform parameter and a forth input terminal for receiving said decoded value and having an output terminal, said scan approximation means for refining said coefficients of previous scan by performing point transform and updating non-zero coefficient indicating bits to provide updated coefficients and indicating bits; and
a switch having a first input terminal for receiving said decoded value, a second input terminal for receiving said updated coefficients and indicating bits and a third input terminal for receiving said scan number and having an output terminal, said switch for choosing said decoded value when said scan number indicates the first scan and choosing said updated coefficients and indicating bits when said scan number indicates the subsequent scans to provide updated coefficients and non-zero coefficient indicating bits.

15. The apparatus set forth in claim 3 wherein said multiple-scan resolution refining means comprises:
a scan approximation means having a first input terminal for receiving said coefficients of previous scan, a second input terminal for receiving said correction bits, a third input terminal for receiving said point transform parameter and a forth input terminal for receiving said decoded value and having an output terminal, said scan approximation means for refining said coefficients of previous scan by performing point transform and updating non-zero coefficient indicating bits to provide updated coefficients and indicating bits; and
a switch having a first input terminal for receiving said decoded value, a second input terminal for receiving said updated coefficients and indicating bits and a third input terminal for receiving said scan number and having an output terminal, said switch for choosing said decoded value when said scan number indicates the first scan and choosing said updated coefficients and indicating bits when said scan number indicates the subsequent scans to provide updated coefficients and non-zero coefficient indicating bits.

16. The apparatus set forth in claim 4 wherein said multiple-scan resolution refining means comprises:
a scan approximation means having a first input terminal for receiving said coefficients of previous scan, a second input terminal for receiving said correction bits, a third input terminal for receiving said point transform parameter and a forth input terminal for receiving said decoded value and having an output terminal, said scan approximation means for refining said coefficients of previous scan by performing point transform and updating non-zero coefficient indicating bits to provide updated coefficients and indicating bits; and
a switch having a first input terminal for receiving said decoded value, a second input terminal for receiving said updated coefficients and indicating bits and a third input terminal for receiving said scan number and having an output terminal, said switch for choosing said decoded value when said scan number indicates the first scan and choosing said updated coefficients and indicating bits when said scan number indicates the subsequent scans to provide updated coefficients and non-zero coefficient indicating bits.

17. The apparatus set forth in claim 5 wherein said multiple-scan resolution refining means comprises:
a scan approximation means having a first input terminal for receiving said coefficients of previous scan, a second input terminal for receiving said correction bits, a third input terminal for receiving said point transform parameter and a forth input terminal for receiving said decoded value and having an output terminal, said scan approximation means for refining said coefficients of previous scan by performing point transform and updating non-zero coefficient indicating bits to provide updated coefficients and indicating bits; and
a switch having a first input terminal for receiving said decoded value, a second input terminal for receiving said updated coefficients and indicating bits and a third input terminal for receiving said scan number and having an output terminal, said switch for choosing said decoded value when said scan number indicates the first scan and choosing said updated coefficients and indicating bits when said scan number indicates the subsequent scans to provide updated coefficients and non-zero coefficient indicating bits.

18. The apparatus set forth in claim 6 wherein said multiple-scan resolution refining means comprises:
a scan approximation means having a first input terminal for receiving said coefficients of previous scan, a second input terminal for receiving said correction bits, a third input terminal for receiving said point transform parameter and a forth input terminal for receiving said decoded value and having an output terminal, said scan approximation means for refining said coefficients of previous scan by performing point transform and updating non-zero coefficient indicating bits to provide updated coefficients and indicating bits; and
a switch having a first input terminal for receiving said decoded value, a second input terminal for receiving said updated coefficients and indicating bits and a third input terminal for receiving said scan number and having an output terminal, said switch for choosing said decoded value when said scan number indicates the first scan and choosing said updated coefficients and indicating bits when said scan number indicates the subsequent scans to provide updated coefficients and non-zero coefficient indicating bits.

19. The apparatus set forth in claim 7 wherein said multiple-scan resolution refining means comprises:
a scan approximation means having a first input terminal for receiving said coefficients of previous scan, a second input terminal for receiving said correction bits, a third input terminal for receiving said point transform parameter and a forth input terminal for receiving said decoded value and having an output terminal, said scan approximation means for refining said coefficients of previous scan by performing point transform and updating non-zero coefficient indicating bits to provide updated coefficients and indicating bits; and
a switch having a first input terminal for receiving said decoded value, a second input terminal for receiving said updated coefficients and indicating bits and a third input terminal for receiving said scan number and having an output terminal, said switch for choosing said decoded value when said scan number indicates the first scan and choosing said updated coefficients and indicating bits when said scan number indicates the subsequent scans to provide updated coefficients and non-zero coefficient indicating bits.

20. The apparatus set forth in claim 14 wherein said scan approximation means comprises:
an indicating bit updating means having an input terminal for receiving said decoded value and having an output terminal, said indicating bit updating means for updating zero-coefficient indicating bit from “0” to “1” if a valid decoded value is non-zero and keeping zero-coefficient indicating bit as “0” if the valid decoded value is zero for coefficient outside the masking area; and
a point transform means having a first input terminal for receiving said correction bits and a second input terminal for receiving said point transform parameter and having an output terminal, said point transform means for generating point transformed value by shifting said correction bits with one of a plurality of number of bits specified by said point transform parameter; and
a selector having a first input terminal for receiving said decoded value, a second input terminal for receiving said point transformed value and a third input terminal for receiving said indicating bitmap of previous scan or said non-zero coefficient indicating bits of previous scan and having an output terminal, said selector for generating selected value by choosing said decoded value when its third input terminal receives a “0” and choosing said point transformed value when its third input terminal receives a “1”; and
an adding means having a first input terminal for receiving said selected value and a second input terminal for receiving said coefficients of previous scan and having an output terminal, said adding means for summing up said selected value and said coefficients of previous scan to generate updated coefficients; and
a multiplexing means having a first input terminal for receiving said updated indicating bits and a second input terminal for receiving said updated coefficients and having an output terminal, said multiplexing means for combining said updated indicating bits and said updated coefficients to provide said updated coefficients and indicating bits.

21. The apparatus set forth in claim 15 wherein said scan approximation means comprises:
an indicating bit updating means having an input terminal for receiving said decoded value and having an output terminal, said indicating bit updating means for updating zero-coefficient indicating bit from “0” to “1” if a valid decoded value is non-zero and keeping zero-coefficient indicating bit as “0” if the valid decoded value is zero for coefficient outside the masking area; and
a point transform means having a first input terminal for receiving said correction bits and a second input terminal for receiving said point transform parameter and having an output terminal, said point transform means for generating point transformed value by shifting said correction bits with one of a plurality of number of bits specified by said point transform parameter; and
a selector having a first input terminal for receiving said decoded value, a second input terminal for receiving said point transformed value and a third input terminal for receiving said indicating bitmap of previous scan or said non-zero coefficient indicating bits of previous scan and having an output terminal, said selector for generating selected value by choosing said decoded value when its third input terminal receives a “0” and choosing said point transformed value when its third input terminal receives a “1”; and
an adding means having a first input terminal for receiving said selected value and a second input terminal for receiving said coefficients of previous scan and having an output terminal, said adding means for summing up said selected value and said coefficients of previous scan to generate updated coefficients; and
a multiplexing means having a first input terminal for receiving said updated indicating bits and a second input terminal for receiving said updated coefficients and having an output terminal, said multiplexing means for combining said updated indicating bits and said updated coefficients to provide said updated coefficients and indicating bits.

22. The apparatus set forth in claim 16 wherein said scan approximation means comprises:
an indicating bit updating means having an input terminal for receiving said decoded value and having an output terminal, said indicating bit updating means for updating zero-coefficient indicating bit from “0” to “1” if a valid decoded value is non-zero and keeping zero-coefficient indicating bit as “0” if the valid decoded value is zero for coefficient outside the masking area; and
a point transform means having a first input terminal for receiving said correction bits and a second input terminal for receiving said point transform parameter and having an output terminal, said point transform means for generating point transformed value by shifting said correction bits with one of a plurality of number of bits specified by said point transform parameter; and
a selector having a first input terminal for receiving said decoded value, a second input terminal for receiving said point transformed value and a third input terminal for receiving said indicating bitmap of previous scan or said non-zero coefficient indicating bits of previous scan and having an output terminal, said selector for generating selected value by choosing said decoded value when its third input terminal receives a “0” and choosing said point transformed value when its third input terminal receives a “1”; and
an adding means having a first input terminal for receiving said selected value and a second input terminal for receiving said coefficients of previous scan and having an output terminal, said adding means for summing up said selected value and said coefficients of previous scan to generate updated coefficients; and
a multiplexing means having a first input terminal for receiving said updated indicating bits and a second input terminal for receiving said updated coefficients and having an output terminal, said multiplexing means for combining said updated indicating bits and said updated coefficients to provide said updated coefficients and indicating bits.

23. The apparatus set forth in claim 17 wherein said scan approximation means comprises:
an indicating bit updating means having an input terminal for receiving said decoded value and having an output terminal, said indicating bit updating means for updating zero-coefficient indicating bit from “0” to “1” if a valid decoded value is non-zero and keeping zero-coefficient indicating bit as “0” if the valid decoded value is zero for coefficient outside the masking area; and
a point transform means having a first input terminal for receiving said correction bits and a second input terminal for receiving said point transform parameter and having an output terminal, said point transform means for generating point transformed value by shifting said correction bits with one of a plurality of number of bits specified by said point transform parameter; and
a selector having a first input terminal for receiving said decoded value, a second input terminal for receiving said point transformed value and a third input terminal for receiving said indicating bitmap of previous scan or said non-zero coefficient indicating bits of previous scan and having an output terminal, said selector for generating selected value by choosing said decoded value when its third input terminal receives a “0” and choosing said point transformed value when its third input terminal receives a “1”; and
an adding means having a first input terminal for receiving said selected value and a second input terminal for receiving said coefficients of previous scan and having an output terminal, said adding means for summing up said selected value and said coefficients of previous scan to generate updated coefficients; and
a multiplexing means having a first input terminal for receiving said updated indicating bits and a second input terminal for receiving said updated coefficients and having an output terminal, said multiplexing means for combining said updated indicating bits and said updated coefficients to provide said updated coefficients and indicating bits.

24. The apparatus set forth in claim 18 wherein said scan approximation means comprises:
an indicating bit updating means having an input terminal for receiving said decoded value and having an output terminal, said indicating bit updating means for updating zero-coefficient indicating bit from “0” to “1” if a valid decoded value is non-zero and keeping zero-coefficient indicating bit as “0” if the valid decoded value is zero for coefficient outside the masking area; and
a point transform means having a first input terminal for receiving said correction bits and a second input terminal for receiving said point transform parameter and having an output terminal, said point transform means for generating point transformed value by shifting said correction bits with one of a plurality of number of bits specified by said point transform parameter; and
a selector having a first input terminal for receiving said decoded value, a second input terminal for receiving said point transformed value and a third input terminal for receiving said indicating bitmap of previous scan or said non-zero coefficient indicating bits of previous scan and having an output terminal, said selector for generating selected value by choosing said decoded value when its third input terminal receives a “0” and choosing said point transformed value when its third input terminal receives a “1”; and
an adding means having a first input terminal for receiving said selected value and a second input terminal for receiving said coefficients of previous scan and having an output terminal, said adding means for summing up said selected value and said coefficients of previous scan to generate updated coefficients; and
a multiplexing means having a first input terminal for receiving said updated indicating bits and a second input terminal for receiving said updated coefficients and having an output terminal, said multiplexing means for combining said updated indicating bits and said updated coefficients to provide said updated coefficients and indicating bits.

25. The apparatus set forth in claim 19 wherein said scan approximation means comprises:
an indicating bit updating means having an input terminal for receiving said decoded value and having an output terminal, said indicating bit updating means for updating zero-coefficient indicating bit from “0” to “1” if a valid decoded value is non-zero and keeping zero-coefficient indicating bit as “0” if the valid decoded value is zero for coefficient outside the masking area; and
a point transform means having a first input terminal for receiving said correction bits and a second input terminal for receiving said point transform parameter and having an output terminal, said point transform means for generating point transformed value by shifting said correction bits with one of a plurality of number of bits specified by said point transform parameter; and
a selector having a first input terminal for receiving said decoded value, a second input terminal for receiving said point transformed value and a third input terminal for receiving said indicating bitmap of previous scan or said non-zero coefficient indicating bits of previous scan and having an output terminal, said selector for generating selected value by choosing said decoded value when its third input terminal receives a “0” and choosing said point transformed value when its third input terminal receives a “1”; and
an adding means having a first input terminal for receiving said selected value and a second input terminal for receiving said coefficients of previous scan and having an output terminal, said adding means for summing up said selected value and said coefficients of previous scan to generate updated coefficients; and
a multiplexing means having a first input terminal for receiving said updated indicating bits and a second input terminal for receiving said updated coefficients and having an output terminal, said multiplexing means for combining said updated indicating bits and said updated coefficients to provide said updated coefficients and indicating bits.
